(19) United States
(12) Patent Application Publication
(10) Pub. No.: US 2023/0154307 A1
(43) Pub. Date: May 18, 2023

(54) ACCIDENT SIGN DETECTION SYSTEM AND ACCIDENT SIGN DETECTION METHOD

(71) Applicant: PANASONIC INTELLECTUAL PROPERTY MANAGEMENT CO., LTD., Osaka (JP)

(72) Inventor: Akio NAKASHIMA, Tokyo (JP)

(73) Assignee: PANASONIC INTELLECTUAL PROPERTY MANAGEMENT CO., LTD., Osaka (JP)

(21) Appl. No.: 17/917,497

(22) PCT Filed: Apr. 1, 2021
(86) PCT No.: PCT/JP2021/014180

§ 371 Date: Oct. 6, 2022

(30) Foreign Application Priority Data
Apr. 9, 2020 (JP) 2020-070541

(51) Int. Cl. G08B 25/00; G08B 21/02; G06V 20/52; G06V 40/20

(52) U.S. Cl. CPC G08B 25/006; G08B 21/02; G06V 20/52; G06V 40/20

(57) ABSTRACT

Provided is a system used in various facilities, which enables every specific event as a sign of an accident to be detected without missing to ensure transmission of an alert message at a proper time, thereby preventing accidents from occurring. The system includes cameras for capturing images of a monitoring area, and a monitoring server for controlling transmission of an alert message based on the images, wherein the monitoring server is configured to: set a sensing area around an entrance to a risky point (escalator entrance) and a notifying area closer to the risky point than the sensing area; sense a person in the sensing area and detect a specific event associated with the person based on images captured by each camera; and, when the sensed person enters the notifying area, transmits an alert message corresponding to the specific event associated with the person.

### TECHNICAL FIELD

The present invention relates to an accident sign detection system and an accident sign detection method for detecting a sign of an accident and controlling transmission of an alert message by using image analysis on captured images of a predetermined monitoring area in a facility.

### BACKGROUND ART

In commercial facilities such as shopping malls, leisure facilities such as entertainment parks, and public transportation facilities such as airports, there are places where accidents are prone to occur (places where users often stumble and fall, such as escalators and stairs). Thus, there is a need for technologies for preventing accidents at such places.

Known technologies for preventing accidents from occurring in various facilities include a system which includes a camera for capturing images of a monitoring area where accidents are prone to occur (such as conveyers for transporting people), and a control device configured such that, when detecting an abnormal status of a user (such as user's falling, reverse movement, leaning out, sitting, or moving with too many people) using image analysis on the captured images, the control device provides an announcement for alert notification and/or performs operation controls (such as deceleration and stop) to ensure safety of users (Patent Document 1).

### PRIOR ART DOCUMENT (S)

### Patent Document(s)

Patent Document 1: JP2011-195289A

### SUMMARY OF THE INVENTION

### Task to be Accomplished by the Invention

In such a system, in order to detect an abnormal status of a person based on images captured by a camera, the system preferably recognizing objects around a person concurrently with sensing the person in a monitoring area. However, such a person or an object around the person is sometimes partially or totally hidden by another person and/or another object, which prevents the system from properly sensing the person and/or properly recognizing the objects around the person. In this case, the system may temporarily become unable to sense a person, or become unable to detect an abnormal status of a person even when the person is sensed.

In addition, such systems of the prior art generally perform operation controls related to a person who has already entered an accident-prone place, e.g., an escalator (a conveyer for transporting people). Thus, when a person is hidden by another thing, the system temporarily becomes unable to sense the person or unable to detect an abnormal status of the person, which would cause a problem that it becomes too late to take measures to ensure safety of users.

The present invention has been made in view of the problem of the prior art, and a primary object of the present invention is to provide an accident sign detection system and an accident sign detection method used in various facilities, which enables every specific event that is a sign of an accident to be detected without missing to ensure transmission of an alert message at a proper time, thereby preventing accidents from occurring.

### Means to Accomplish the Task

An aspect of the present invention provides an accident sign detection system for detecting a sign of an accident and controlling transmission of an alert message by using image analysis on captured images of a predetermined monitoring area in a facility, the system comprising: a plurality of cameras for capturing images of the monitoring area; a processing device configured to sense a person in the monitoring area and detect a specific event associated with the person, the specific event being a sign of an accident, based on the images captured by the cameras, and control transmission of an alert message according to characteristics of the specific event, wherein the processing device is configured to: set a first area used for detecting the specific event and a second area used for controlling the transmission of the alert message, the first and second areas being included in the monitoring area; acquire, based on images captured by each of the plurality of cameras, a person sensing result consisting of results of sensing the person in the first area and in the second area and a specific event detecting result consisting of a result of detecting the specific event in the first area; acquire characteristics of the specific event from a combination of the person sensing result and the specific event detecting result; and control the transmission of the alert message according to the characteristics of the specific event.

Another aspect of the present invention provides an accident sign detection method for detecting a sign of an accident and controlling transmission of an alert message by using image analysis on captured images of a predetermined monitoring area in a facility, wherein the method is performed by a processing device, the method comprising: setting a first area used for detecting the specific event and a second area used for controlling the transmission of the alert message, the first and second areas being included in the monitoring area; acquiring, based on images captured by each of a plurality of cameras, a person sensing result consisting of results of sensing the person in the first area and in the second area and a specific event detecting result consisting of a result of detecting a specific event in the first area; acquiring characteristics of the specific event from a combination of the person sensing result and the specific event detecting result; and controlling the transmission of the alert message according to the characteristics of the specific event to control.

### Effect of the Invention

According to the present invention, a plurality of cameras are used to capture images, based on which a person is sensed and a specific event is detected. Thus, even when one camera can only capture an image in which a person is partially or totally hidden, another camera can capture an image based on which sensing of a person and detecting a specific event are successfully done. As a result, every specific event that is a sign of an accident can be detected without missing, which ensures transmission of an alert message at a proper time, thereby preventing accidents from occurring.

### BRIEF DESCRIPTION OF THE DRAWINGS

FIG. 1 is a diagram showing an overall configuration of an accident sign detection system according to one embodiment of the present invention;

FIG. 2 is an explanatory diagram showing an arrangement of cameras 1, and a monitoring area in which a sensing area and a notifying area are set;

FIG. 3 is a block diagram showing a schematic configuration of a monitoring server 2;

FIG. 4 is an explanatory diagram showing an outline of processing operations performed by the monitoring server 2;

FIG. 5 is an explanatory diagram showing an area setting screen displayed on an administrator terminal 4;

FIG. 6 is an explanatory diagram showing contents of risk level setting information used in the monitoring server 2;

FIG. 7 is an explanatory diagram showing an alert message setting screen displayed on the administrator terminal 4;

FIG. 8 is an explanatory diagram showing data sets registered in a person database managed by the monitoring server 2;

FIG. 9 is a flow chart showing a procedure of an image analysis operation performed by the monitoring server 2; and

FIG. 10 is a flow chart showing a procedure of alert-related operations performed by the monitoring server 2.

### DESCRIPTION OF THE PREFERRED EMBODIMENT(S)

A first aspect of the present invention made to achieve the above-described object is an accident sign detection system for detecting a sign of an accident and controlling transmission of an alert message by using image analysis on captured images of a predetermined monitoring area in a facility, the system comprising: a plurality of cameras for capturing images of the monitoring area; a processing device configured to sense a person in the monitoring area and detect a specific event associated with the person, the specific event being a sign of an accident, based on the images captured by the cameras, and control transmission of an alert message according to characteristics of the specific event, wherein the processing device is configured to: set a first area used for detecting the specific event and a second area used for controlling the transmission of the alert message, the first and second areas being included in the monitoring area; acquire, based on images captured by each of the plurality of cameras, a person sensing result consisting of results of sensing the person in the first area and in the second area and a specific event detecting result consisting of a result of detecting the specific event in the first area; acquire characteristics of the specific event from a combination of the person sensing result and the specific event detecting result; and control the transmission of the alert message according to the characteristics of the specific event.

In this configuration, a plurality of cameras are used to capture images, based on which a person is sensed and a specific event is detected. Thus, even when one camera can only capture an image in which a person is partially or totally hidden, another camera can capture an image based on which sensing of a person and detecting a specific event are successfully done. As a result, every specific event that is a sign of an accident can be detected without missing, which ensures transmission of an alert message at a proper time, thereby preventing accidents from occurring.

A second aspect of the present invention is the accident sign detection system of the first aspect, wherein the plurality of cameras are installed such that the plurality of cameras shoot a person in the monitoring area from different angles to thereby provide images of opposite sides of the person.

In this configuration, when one camera only captures an image in which a person is partially or totally hidden, another camera can properly capture an image of the person. As a result, missing out on sensing a person and detecting a specific event can be minimized.

A third aspect of the present invention is the accident sign detection system of the first aspect, wherein the processing device is configured to set the second area within the first area for each image captured by the plurality of cameras.

In this configuration, when a user passes through the first area and enters the second area, detection of a specific event associated with the user and transmission of an alert message therefor can be done more properly.

A fourth aspect of the present invention is the accident sign detection system of the first aspect, wherein the processing device is configured to: store setting information on contents to be included in alert messages, each content being associated with a corresponding type of a specific event; and control the transmission of the alert message based on the content included in the alert message, the content being associated with the type of the detected specific event.

In this configuration, a content included in an alert message to be transmitted can be changed according to the type of a specific event.

A fifth aspect of the present invention is the accident sign detection system of the fourth aspect, wherein the processing device is configured to: cause an administrator device for an administrator to display a screen related to the setting information, so that the setting information can be updated according to the administrator's operation on the screen.

This configuration enables an administrator to change each content, the content being included in an alert message, associated with a corresponding type of a specific event.

A sixth aspect of the present invention is the accident sign detection system of the first aspect, wherein the processing device is configured to: recognize an object in the first area based on an image of the first area; and associate the person sensed in the first area with the object recognized in the first area to thereby determine a type of the specific event.

This configuration enables more accurate detection of a specific event that is a sign of an accident.

A seventh aspect of the present invention is the accident sign detection system of the first aspect, wherein the processing device is configured to: associate sensed persons in images captured at different times with each other and also associate sensed persons in images captured by each of the cameras with each other to thereby track each person in the monitoring area.

In this configuration, even when a person is hidden by another thing so that the system temporarily becomes unable to sense the person, or unable to detect a specific event, the processing device can track each person to hold the detection result of a specific event associated with the person, thereby ensuring that the processing device detects the person associated with the specific event enters the second area.

An eighth aspect of the present invention is an accident sign detection method for detecting a sign of an accident and controlling transmission of an alert message by using image analysis on captured images of a predetermined monitoring area in a facility, wherein the method is performed by a processing device, the method comprising: setting a first area used for detecting the specific event and a second area used for controlling the transmission of the alert message, the first and second areas being included in the monitoring area; acquiring, based on images captured by each of a plurality of cameras, a person sensing result consisting of results of sensing the person in the first area and in the second area and a specific event detecting result consisting of a result of detecting a specific event in the first area; acquiring characteristics of the specific event from a combination of the person sensing result and the specific event detecting result; and controlling the transmission of the alert message according to the characteristics of the specific event to control.

In this configuration, the method, which can be performed in various facilities, enables every specific event that is a sign of an accident to be detected without missing to ensure transmission of an alert message at a proper time, thereby preventing accidents from occurring, in the same manner as the first aspect.

Embodiments of the present invention will be described below with reference to the drawings.

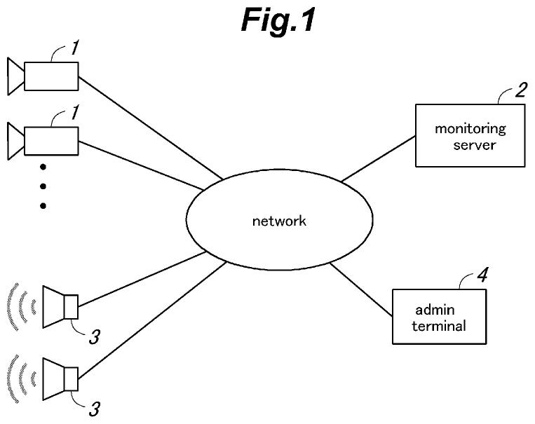

FIG. 1 is a diagram showing an overall configuration of an accident sign detection system according to one embodiment of the present invention.

The accident sign detection system, which can be used in various facilities (e.g., commercial facilities such as shopping malls, leisure facilities such as entertainment parks, and public transportation facilities such as airports), is configured to detect a specific event that is a sign of an accident, and transmit an alert message according to the specific event. The system includes a plurality of cameras 1, a monitoring server 2 (processing device), speakers 3 (notification devices), and an administrator terminal 4 (administrator device), where the cameras 1, the speakers 3, and the administrator terminal 4 are connected to the monitoring server 2 via a network.

The cameras 1 shoot a monitoring area preset in a facility. In the present embodiment, the monitoring area is an area around an entrance to a place (risky point) where an accident is prone to occur, such as an area around the entrance of an escalator or stairs.

The monitoring server 2 is comprised primarily of a personal computer, and is configured to detect a specific event that is a sign of an accident; that is, a status in which an accident can occur (e.g., a status in which users often stumble and fall), based on images captured by the cameras 1, and transmit an alert message using the speakers 3 based on the detection result. In the present embodiment, the monitoring server 2 detects, as a specific event, a person in a wheelchair, a person pushing a stroller, a person pushing a shopping cart, a person having a large item (such as suitcase), or any person having a potential risk of accident.

The monitoring server 2 is installed at an appropriate place in the facility, for example, in a monitoring room. The monitoring server 2 may be a cloud computer connected to the cameras 1 and the speakers 3 in the facility via a wide area network such as the Internet.

The speakers 3 output a voice alert message. The system may include a plurality of installed speakers 3, which include a speaker 3 for users that outputs a voice alert message for users, and a speaker 3 for staff that outputs a voice alert message for staff.

An administrator can operate on the administrator terminal 4 to perform setting operations related to conditions of processing operations performed by the monitoring server 2.

In the present embodiment, the speakers 3 are installed as notification devices for transmission of alert messages, and used for outputting voice alert messages. In other embodiments, warning lights may be turned on for providing alert messages. In this case, warning lights may appear in a different color according to the risk level for a detected specific event. In some cases, the administrator terminal 4 may display an alert screen as a form of an alert message.

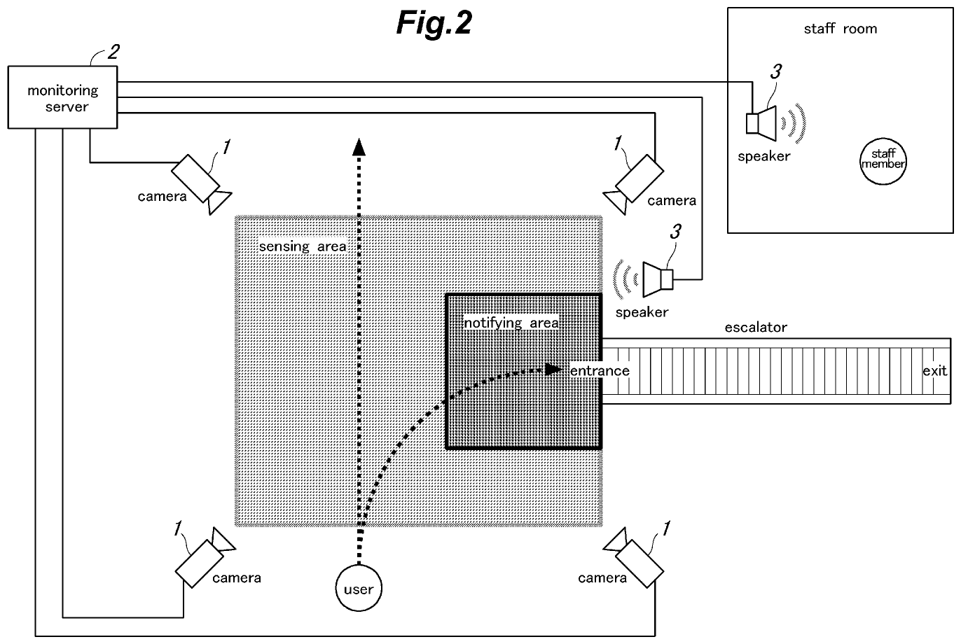

Next, an arrangement of the cameras 1, and the monitoring area including a sensing area and a notifying area will be described. FIG. 2 is an explanatory diagram showing an arrangement of the cameras 1, and the monitoring area in which a sensing area and a notifying area are set.

In the present embodiment, the monitoring area includes a sensing area (first area) around an entrance of an escalator (an entrance to a risky point), and a notifying area (second area) closer to the entrance of the escalator than the sensing area. In the example shown in FIG. 2, the notifying area is determined to have three sides surrounded by the sensing area and the other one side facing the entrance of the escalator in the notifying area.

The sensing area is an area for detecting a specific event that is a sign of an accident. When a person enters the sensing area, the monitoring server 2 detects the person from images captured by the cameras 1 and further determines whether or not the person is associated with a specific event. The notifying area is an area for determining whether or not transmission of an alert message is necessary. After the monitoring server 2 determines that a person in the sensing area is associated with a specific event, when the person enters the notifying area, the monitoring server 2 transmits an alert message according to the characteristics of a specific event associated with the person.

In the present embodiment, multiple cameras 1 are installed so as to capture images of the monitoring area (the sensing area and the notifying area). The cameras 1 are installed so as to shoot a person who has entered the monitoring area (the sensing area and the notifying area) from different angles to thereby provide images of opposite sides of the person. In the example shown in FIG. 2, four cameras 1 are installed. Each pair of the cameras 1 are installed facing each other in a diagonal direction of the monitoring areas (the sensing area and the notifying area), the monitoring area being set to have a rectangular shape.

Thus, even when one camera can only capture an image(s) in which a person is partially or totally hidden, another camera can capture an image(s), based on which the monitoring server 2 can successfully sense the person and/or detect a specific event associated with the person. As a result, every specific event that is a sign of an accident can be detected without missing, which ensures transmission of an alert message in response to the detection of a specific event.

In the present embodiment, the notifying area is set to be near the entrance of the escalator, and the sensing area is set around the notifying area. Thus, before boarding the escalator, a user usually passes through the sensing area and the notifying area in this order. Accordingly, the monitoring server 2 determines whether or not a user is associated with a specific event at the time when the user enters the sensing area; that is, before the user enters the notifying area. Therefore, the monitoring server 2 can find a person associated with a specific event, such as a person who is more likely to fall at the entrance of the escalator, at an earlier time.

In the present embodiment, the monitoring server 2 received captured images periodically provided from the cameras 1, and performs operations for sensing a person and detecting a specific event based on captured images (frames) at each time of receiving a corresponding set of image. Then, the monitoring server 2 associates sensed persons (person images) in images captured at different times with each other and also associates sensed persons (person images) in images captured by each of the plurality of cameras with each other, thereby tracking each person who has entered the monitoring area.

As a result, even when a person is hidden by another thing so that the system temporarily becomes unable to sense the person, or unable to detect a specific event, the monitoring server 2 can track each person to hold the detection result of a specific event associated with the person, thereby ensuring that the monitoring server 2 detects that the person associated with the specific event enters the second area. In other words, even when a person is hidden by another thing in images captured by a camera 1, based on which the system is unable to detect a specific event associated with the person when the person enters the notifying area, the monitoring server can specify characteristics of a specific event associated with the person. This ensures transmission of an alert message at a proper time, thereby preventing accidents from occurring.

When a person who enters the sensing area passes through the sensing area and does not enter the notifying area; that is, the person is not boarding the escalator, the monitoring server 2 does not transmit an alert message.

In the present embodiment, even after a person enters the notifying area, the system continues to perform operations for sensing a person and detecting a specific event. Thus, in the case of failure to track a person, the monitoring server newly detects a person in the notifying area, and when the detected person is associated with a specific event, the monitoring server transmits an alert message.

In the present embodiment, the speaker 3 for users is installed near the monitoring area (sensing area and notifying area). The speaker 3 for users outputs a voice alert message for users. The speaker 3 for staff is installed in a staff room. The speaker 3 for staff outputs a voice alert message for staff.

In the present embodiment, an area around the entrance of an escalator is monitored as an accident-prone place (risky point) where an accident may occur. However, a place to be monitored is not limited to one around the entrance of an escalator, and may be a place around the entrance of stairs, for example.

In the example shown in FIG. 2, the sensing area is set around the notifying area. However, the sensing area may be separated from the notifying area. Furthermore, the sensing area and the notifying area are not limited to a rectangle, and may have a semicircular shape or any other proper shape.

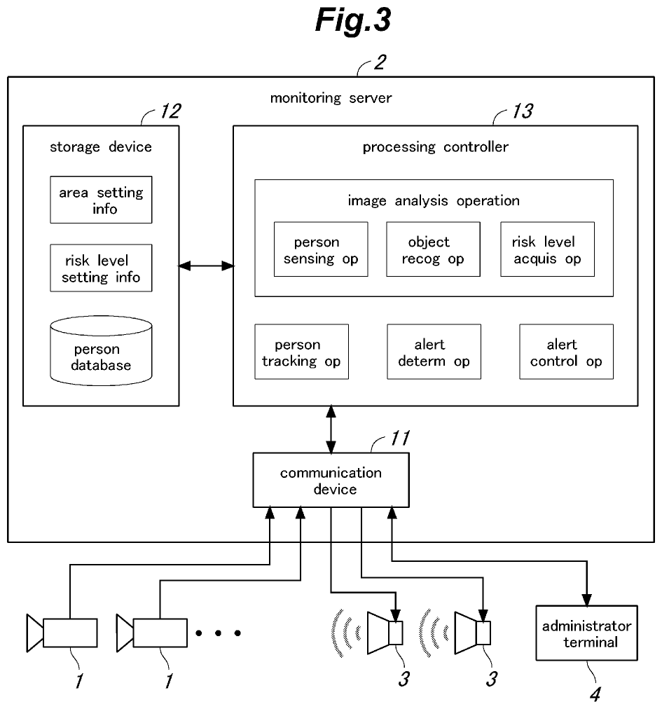

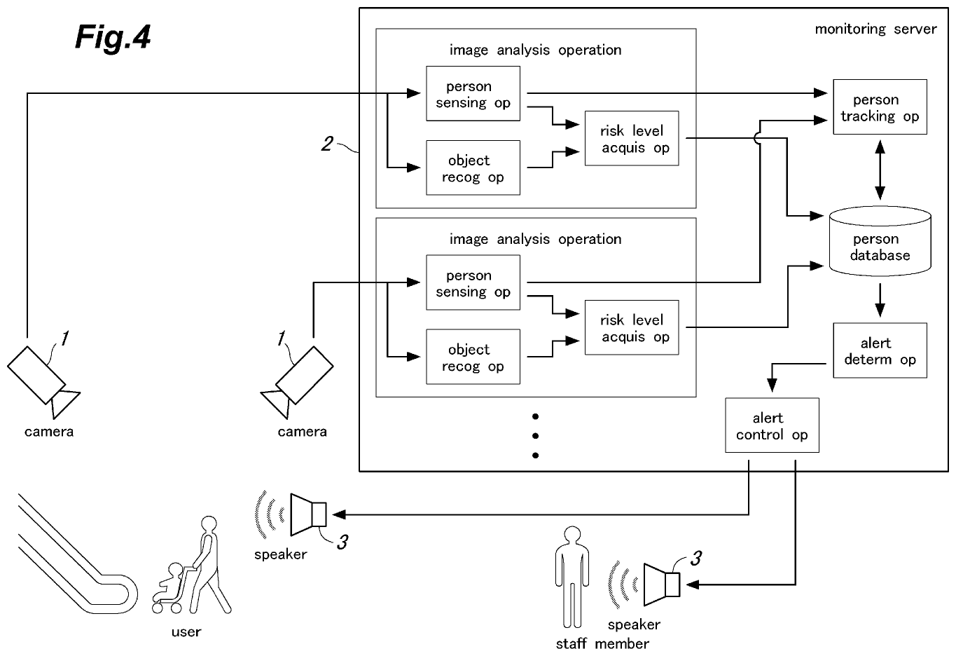

Next, a schematic configuration of the monitoring server 2 will be described. FIG. 3 is a block diagram showing a schematic configuration of the monitoring server 2, and FIG. 4 is an explanatory diagram showing an outline of processing operations performed by the monitoring server 2.

The monitoring server 2 includes a communication device 11, a storage device 12, and a processing controller 13.

The communication device 11 communicates with the cameras 1, the speakers 3, and the administrator terminal 4 via a network.

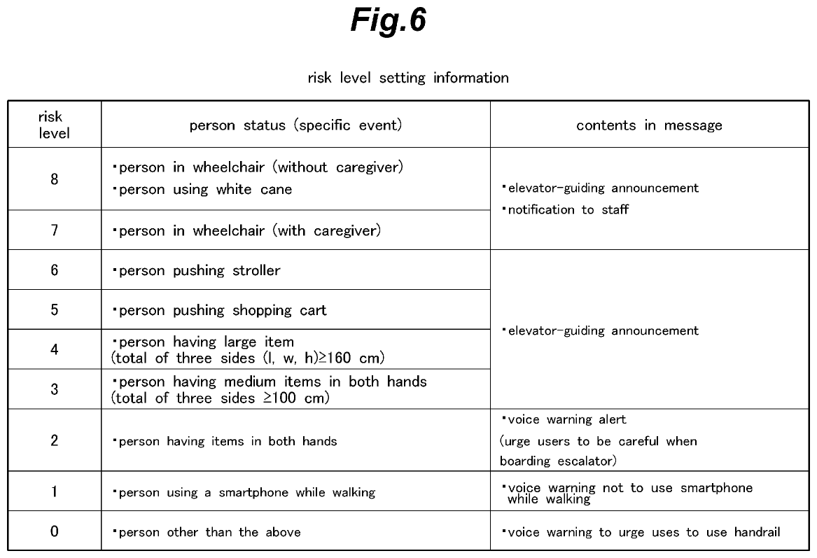

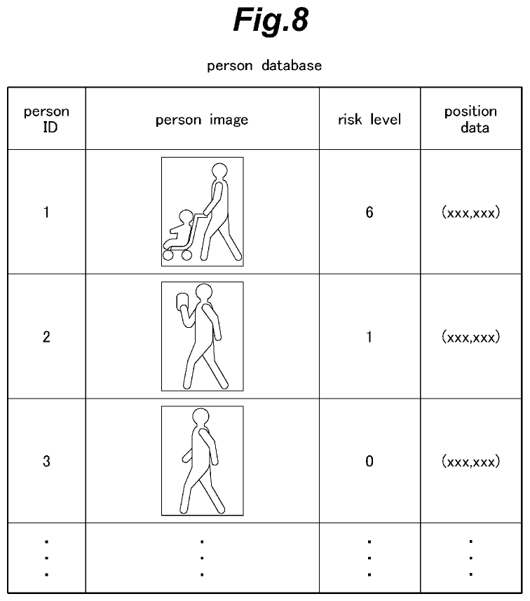

The storage device 12 stores programs to be executed by the processing controller 13 and other data. The storage device 12 also stores area setting information and risk level setting information (see FIG. 6). The area setting information is information indicating respective regions of the sensing area and the notifying area. The risk level setting information includes contents to be included in alert messages for different risk levels, each risk level being determined based on characteristics of a specific event. The storage device 12 stores data sets registered in a person database (see FIG. 8). The person database contains a data set related to each person acquired by the image analysis operation on images captured by the cameras 1.

The processing controller 13 performs various processing operations related to information collection by executing programs stored in the storage device 12. In the present embodiment, the processing controller 13 performs an image analysis operation, a person tracking operation, an alert determination operation, an alert control operation, and other operations.

In the image analysis operation, the processing controller 13 performs image analysis on images (frames) captured by the cameras 1. The image analysis operation includes a person sensing operation, an object recognition operation, and a risk level acquisition operation. The processing controller 13 performs the image analysis operation separately for each of the cameras 1. Furthermore, the processing controller 13 performs the image analysis operation every time captured images (frames) are provided from a camera 1.

In the person sensing operation, the processing controller 13 senses a person in the sensing area based on images captured by the cameras 1 and the area setting information stored in the storage device 12.

In the object recognition operation, the processing controller 13 recognizes an object in the sensing area based on images captured by the cameras 1 and the area setting information stored in the storage device 12. Specifically, the processing controller 13 recognizes an object associated with a specific event that is a sign of an accident. Examples of such objects include a wheelchair, a cane, a luggage item (such as a suitcase), a smartphone, a stroller, and a shopping cart.

In the risk level acquisition operation, the processing controller 13 associates a target person sensed in the sensing area with an object recognized near the person. The processing controller 13 also associates the target person with a caregiver person sensed near the person. Then, the processing controller 13 determines whether or not the sensed person is associated with a specific event, and when the person is associated with a specific event, acquires a risk level based on the risk level setting information stored in the storage device 12. Specifically, the processing controller 13 determines the type of a specific event and acquires the risk level corresponding to the type of the specific event.

In the person tracking operation, the processing controller 13 performs a person matching (identifying) operation to determine whether or not the person (target person) sensed in the person sensing operation is a person registered in the person database (a registered person). Then, based on a result of the person matching operation, the processing controller 13 associates the target person with a registered person.

The processing controller 13 performs the person matching operation using a machine learning model such as a deep learning model. Specifically, by inputting a person image of a registered person and that of a target person to the machine learning model, the processing controller 13 acquires a person matching score as output data of the machine learning model, the person matching score indicating the degree of possibility that the target person and the registered person are the same person. By comparing the person matching score and a predetermined threshold value, the processing controller 13 can provide a determination result as to whether or not the target person is a registered person. In other cases, the person matching operation may be performed by comparing feature data extracted from a person image of the target person with that of a registered person.

In the alert determination operation, the processing controller 13 determines whether or not a person is present in the notifying area; that is, whether or not the person sensed in the sensing area has entered the notifying area, based on the position data of each registered person contained in the person database and the area setting information stored in the storage device 12.

In the alert control operation, the processing controller 13 acquires characteristics of a specific event associated with the person who has determined to have entered the notifying area in the alert determination operation, and controls transmission of an alert message to the target person, based on the characteristics of the specific event. Specifically, based on the risk level setting information stored in the storage device 12, the processing controller 13 acquires a risk level of the person who has entered the notifying area, and transmits an alert message corresponding to the risk level (the type of specific event) associated with the person. Specifically, the processing controller 13 uses the speaker 3 for users to provide a voice alert message corresponding to the risk level, to users. When the risk level is high, the processing controller 13 also uses the speaker 3 for staff to provide a voice alert message to staff members.

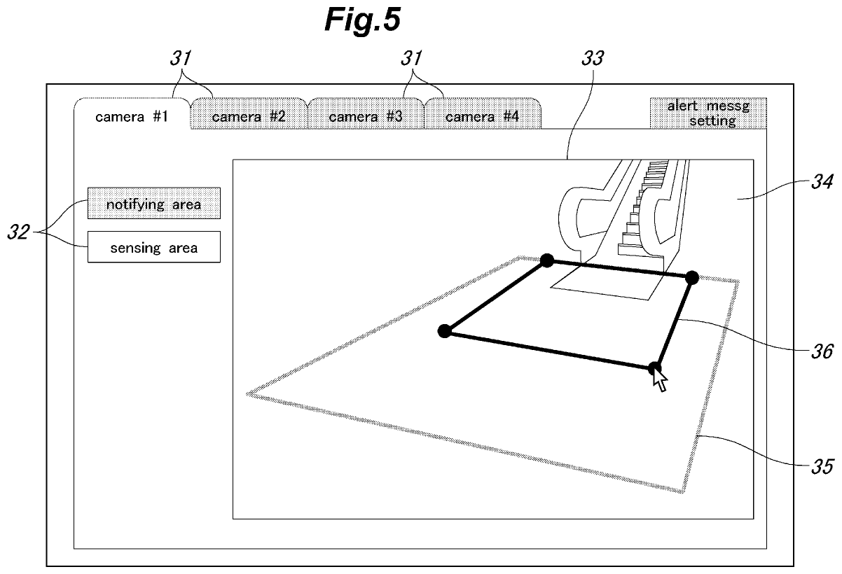

Next, an area setting screen displayed on the administrator terminal 4 will be described. FIG. 5 is an explanatory diagram showing an area setting screen displayed on the administrator terminal 4.

When an administrator causes the administrator terminal 4 to access the monitoring server 2 and selects the setting menu, the area setting screen is displayed on the administrator terminal 4.

The area setting screen includes camera selection tabs 31. In the example, an administrator operates on a camera selection tab 31 to select the camera 1 as a target of setting.

The area setting screen also includes a mode selection button 32. An administrator can operate the mode selection button 32 to switch between a sensing area entry mode and a notifying area entry mode.

The area setting screen also includes a captured image indicator 33. The captured image indicator 33 displays images 34 captured by the selected camera 1.

In the sensing area entry mode, the administrator can operate on the captured image indicator 33 to designate a region of the sensing area in the captured image 34. The designated region of the sensing area is indicated as an area image 35 in the captured image 34. In the notifying area entry mode, the administrator can designate a region of the notifying area in the captured image 34. The designated region of the notifying area is indicated as an area image 36 in the captured image 34. Each of the sensing area and the notifying area may be specified as a polygon.

Specifically, in the sensing area entry mode, by performing prescribed operations on the captured image indicator, the administrator can add polygon vertices representing the region of the sensing area in the captured image 34, adjust the position of each vertex, and delete one of the vertices. The administrator's operations to designate a polygonal area image in the notifying area entry mode are the same as those in the sensing area entry mode.

In both the sensing area entry mode and the notifying area entry mode, the area images 35 and 36 indicating the designated sensing area and the designated notifying area are shown in respective different colors in the captured image 34 displayed on the captured image indicator 33.

When setting each of the sensing area and the notifying area, four markers (such as pieces of adhesive tape) are preferably provided on the floor surface beforehand, such that the four markers' positions correspond to the vertices of a corresponding rectangular area image. By designating a region of the sensing area in each captured image with reference to the images of the sensing area markers, images captured by the different cameras 1 can include respective designated sensing area images of the same sensing area, thereby achieving correspondence of sensing area images in the images of different angles. By designating a region of the notifying area in each captured image with reference to the images of the notifying area markers, images captured by the different cameras 1 can include respective designated notifying area images of the same notifying area, thereby achieving correspondence of notifying area images in the images of different angles.

Next, risk level setting information used in the monitoring server 2 will be described. FIG. 6 is an explanatory diagram showing contents of the risk level setting information.

The risk level setting information includes each risk level, a corresponding type(s) of a specific event, and corresponding contents in alert messages. The risk level is an index indicating the possibility of occurrence of an accident such as a fall. The larger the index value is, the higher the risk level. In the example shown in FIG. 6, the risk levels consist of nine levels from “0” to “8”.

Contents included in alert messages (i.e., contents of announcement made to users) differ depending on the risk level; that is, the type of detected specific event. Specifically, when the risk level of a specific event is high, a guidance announcement is made to stop users from using the escalator (not to enter a risky area). When the risk level of a specific event is low, a warning announcement is made. In addition, when the risk level of a specific event is high, an alert message is also provided to staff, in addition to the announcement to users.

Specifically, in this example, the risk level is “8” when a detected specific event is a person in a wheelchair without a caregiver, or a person using a white cane. The risk level is “7” when a detected specific event is a person in a wheelchair with a caregiver. When the risk level is “8” or “7”, a voice alert message to users is output from the speaker 3 for users, in the form of an elevator-guiding announcement; that is, an announcement made to stop users from using the escalator and encourage them to use an elevator. Furthermore, a voice alert message to staff is also output from the speaker 3 for staff, to notify the staff that a person prone to accidents is boarding the escalator.

The risk level is “6” when a detected specific event is a person pushing a stroller. The risk level is “5” when a detected specific event is a person pushing a shopping cart. The risk level is “4” when a detected specific event is a person having a large item with a total of three sides (length, width, height) that is 160 cm or more. The risk level is “3” when a detected specific event is a person having two medium-sized items each with a total of three sides that is 100 cm or more in both hands. When the risk level is “6” or “3”, a voice alert message to users is output from the speaker 3 for users, in the form of the elevator-guiding announcement.

The risk level is “2” when a detected specific event is a person having items in both hands. In this case, a voice alert message to users is output from the speaker 3 for users, in a form of a warning alert announcement made to urge users to be careful when boarding the escalator.

The risk level is “1” when a detected specific event is a person using a smartphone while walking (a person focusing on a smartphone while walking). In this case, a voice alert message to users is output from the speaker 3 for users, in a form of an alert announcement made to urge users to stop smartphone use while walking.

The risk level is “0” when a sensed person is other than the above; that is, a sensed person is not associated with any specific event. In this case, a voice alert message to users is output from the speaker 3 for users, in a form of an alert announcement made to urge users to use the handrail.

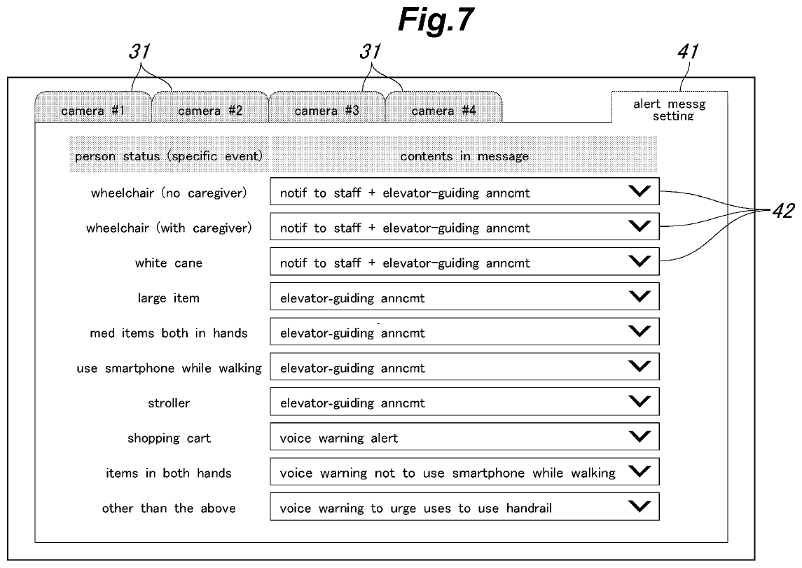

Next, an alert message setting screen displayed on the administrator terminal 4 will be described. FIG. 7 is an explanatory diagram showing the alert message setting screen displayed on the administrator terminal 4.

When an administrator causes the administrator terminal 4 to access the monitoring server 2, selects the setting menu, and operates on an alert message setting button 41, the alert message setting screen is displayed on the administrator terminal 4. An administrator can operate on the alert message setting screen to designate a content of an alert message for each specific event (a specific status of a person).

Specifically, the alert message setting screen includes an alert message selector 42 for each specific event. In the example shown in FIG. 7, the screen shows default contents of alert messages for the respective risk levels of specific events as shown in FIG. 6. A pull-down menu for each risk level is provided to facilitate actual use of the screen, and an administrator can customize (update) contents of alert messages for the respective risk levels by selecting an option of the pull-down menu for each risk level.

Next, a person database managed by the monitoring server 2 will be described. FIG. 8 is an explanatory diagram showing data sets registered in the person database managed by the monitoring server 2.

This person database contains data of results of the image analysis operation (person sensing operation, risk level acquisition operation) on images (frames) captured by the cameras 1. Specifically, as a data set for each sensed person, a person ID, a person image, a risk level, and position data are registered in the person database. Position data for the respective camera (i.e. data indicating positions in images captured by the different cameras) are made common to each other based on the positions of the sets of markers.

A unique person ID is given to a newly sensed person when the new person is sensed in the person sensing operation.

A person image is made by cutting out an image area of a person from an image captured by a camera 1 when the person is sensed in the person sensing operation. The processing controller 13 uses registered person images in the person matching operation included in the person tracking operation, to determine whether or not a newly sensed person is a registered (previously-sensed) person.

A risk level is determined based on a specific event detected in the risk level acquisition operation (event detection operation). The processing controller 13 uses risk levels in the alert control operation. A content of each alert message is determined based on the risk level.

Position data is acquired from the positions of a person in images captured by the cameras 1 when the person is sensed in the person sensing operation. The processing controller 13 uses position data in the alert determination operation; that is, determines whether or not the person has entered the notifying area based on the position data.

A data set for each person registered in the person database is removed when a predetermined time elapses after the sensing of the person. a data set registered in the person database may include, for each person, feature information extracted from a corresponding person image, in addition to or in lieu of the person image.

The person database is updated each time the processing controller 13 performs the image analysis operation (person sensing operation, risk level acquisition operation) on an image (frame) captured by a camera 1. Specifically, when the processing controller 13 newly senses a person in the person sensing operation and determines the risk level in the risk level acquisition operation, the person database is updated by inclusion of additional data for the person i.e., a person ID, a person image, a risk level, and position data related to the person. When the processing controller 13 identifies a person in the person tracking operation, a person image and position data related to the person are added to the person's data set in the person database.

Each time the processing controller 13 performs the image analysis operation (person sensing operation, risk level acquisition operation) on each frame, results of the image analysis operation are registered in the person database. Moreover, each time the processing controller 13 performs the image analysis operation on an image captured by each of the plurality of cameras 1, results of the image analysis operation are registered in the person database. In this way, each data set separately acquired from images captured by a corresponding one of the plurality of cameras 1 is grouped and managed in the person database.

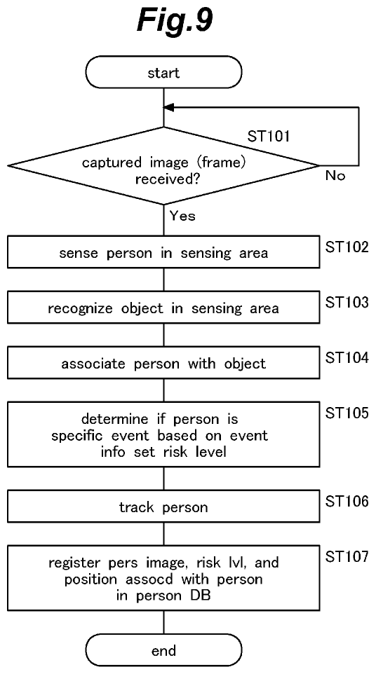

Next, a procedure of the image analysis operation performed by the monitoring server 2 will be described. FIG. 9 is a flow chart showing a procedure of the image analysis operation. The image analysis operation is performed separately for each of the plurality of cameras 1. Furthermore, the processing controller 13 performs the image analysis operation every time it receives a captured image (frame) provided from a camera 1.

In the monitoring server 2, first, when receiving a captured image (frame) from a camera 1 (Yes in ST101), the processing controller 13 senses a person in the sensing area based on the captured image (person sensing operation) (ST102). Then, the processing controller 13 recognizes an object in the sensing area based on the captured image (object recognition operation) (ST103).

Next, the processing controller 13 associates the person sensed in the sensing area with the recognized object (ST104). Next, the processing controller 13 determines whether or not the person is associated with a specific event based on the risk level setting information, and acquires the risk level based on the determination result (risk level acquisition operation) (ST105).

Then, the processing controller 13 performs the person matching (identifying) operation to determine whether or not the person (target person) is a person registered in the person database, and based on the result of the person matching operation, the processing controller 13 associates the target person with a registered person (person tracking operation) (ST106).

Next, the processing controller 13 registers a data set of the target person (person image, risk level, and position data) in the person database (ST107). In this operation, when the target person is a newly sensed person, the processing controller 13 gives a new person ID to the person and registers a data set of the person in the person database. When the person has already been sensed, the processing controller 13 updates the registered data set associated with the person ID in the person database.

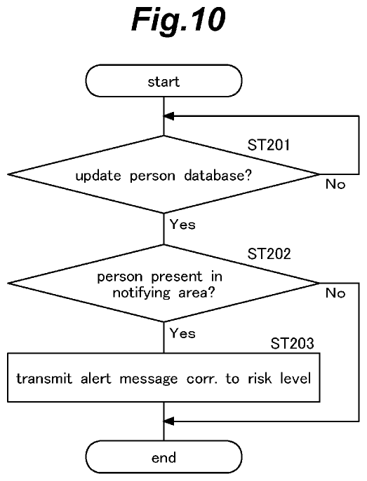

Next, a procedure of alert-related operations performed by the monitoring server 2 will be described. FIG. 10 is a flow chart showing a procedure of the alert-related operations performed by the monitoring server 2.

In the monitoring server 2, first, when the person database is updated (Yes in ST201), the processing controller 13 determines whether or not a person is present in the notifying area based on position data of the person in the person database and the area setting information in the storage device 12 (alert determination operation) (ST202).

In this operation, when the person is present in the notifying area (Yes in ST202), the processing controller 13 controls transmission of an alert message corresponding to the risk level associated with the person based on the risk level setting information stored in the storage device 12. (alert control operation) (ST203).

Specific embodiments of the present invention are described herein for illustrative purposes. However, the present invention is not limited to those specific embodiments, and various changes, substitutions, additions, and omissions may be made for features of the embodiments without departing from the scope of the invention. In addition, elements and features of the different embodiments may be combined with each other to yield an embodiment which is within the scope of the present invention.

### INDUSTRIAL APPLICABILITY

An accident sign detection system and an accident sign detection method according to the present invention achieve an effect of enabling detection of every specific event that is a sign of an accident without missing so as to ensure transmission of an alert message at a proper time, thereby preventing accidents from occurring, and are useful as an accident sign detection system and an accident sign detection method for detecting a sign of an accident and controlling transmission of an alert message by using image analysis on captured images of a predetermined monitoring area in a facility.

### Glossary

1 camera
2 monitoring server (processing device)
3 speaker (notification device)
4 administrator terminal (administrator device)
11 communication device
12 storage device
13 processing controller
31 tab
32 mode selection button
33 captured image indicator
34 captured image
35, 36 area image
41 alert message selector

1. An accident sign detection system for detecting a sign of an accident and controlling transmission of an alert message by using image analysis on captured images of a predetermined monitoring area in a facility, the system comprising:
a plurality of cameras for capturing images of the monitoring area;
a processing device configured to sense a person in the monitoring area and detect a specific event associated with the person, the specific event being a sign of an accident, based on the images captured by the cameras, and control transmission of an alert message according to characteristics of the specific event,
wherein the processing device is configured to:
set a first area used for detecting the specific event and a second area used for controlling the transmission of the alert message, the first and second areas being included in the monitoring area;
acquire, based on images captured by each of the plurality of cameras, a person sensing result consisting of results of sensing the person in the first area and in the second area and a specific event detecting result consisting of a result of detecting the specific event in the first area;
acquire characteristics of the specific event from a combination of the person sensing result and the specific event detecting result; and
control the transmission of the alert message according to the characteristics of the specific event.

2. The accident sign detection system according to claim 1, wherein the plurality of cameras are installed such that the plurality of cameras shoot a person in the monitoring area from different angles to thereby provide images of opposite sides of the person.

3. The accident sign detection system according to claim 1, wherein the processing device is configured to set the second area within the first area for each image captured by the plurality of cameras.

4. The accident sign detection system according to claim 1, wherein the processing device is configured to:
store setting information on contents to be included in alert messages, each content being associated with a corresponding type of a specific event; and
control the transmission of the alert message based on the content included in the alert message, the content being associated with the type of the detected specific event.

5. The accident sign detection system according to claim 4, wherein the processing device is configured to:
cause an administrator device for an administrator to display a screen related to the setting information, so that the setting information can be updated according to the administrator's operation on the screen.

6. The accident sign detection system according to claim 1, wherein the processing device is configured to:
recognize an object in the first area based on an image of the first area; and
associate the person sensed in the first area with the object recognized in the first area to thereby determine a type of the specific event.

7. The accident sign detection system according to claim 1, wherein the processing device is configured to:
associate sensed persons in images captured at different times with each other and also associate sensed persons in images captured by each of the cameras with each other to thereby track each person in the monitoring area.

8. An accident sign detection method for detecting a sign of an accident and controlling transmission of an alert message by using image analysis on captured images of a predetermined monitoring area in a facility, wherein the method is performed by a processing device, the method comprising:
setting a first area used for detecting the specific event and a second area used for controlling the transmission of the alert message, the first and second areas being included in the monitoring area;
acquiring, based on images captured by each of a plurality of cameras, a person sensing result consisting of results of sensing the person in the first area and in the second area and a specific event detecting result consisting of a result of detecting a specific event in the first area;
acquiring characteristics of the specific event from a combination of the person sensing result and the specific event detecting result; and
controlling the transmission of the alert message according to the characteristics of the specific event to control.
